(19) United States
(12) Patent Application Publication
(10) Pub. No.: US 2018/0322809 A1
(43) Pub. Date: Nov. 8, 2018

(54) BIO-MODEL COMPRISING A FLUID SYSTEM AND METHOD OF MANUFACTURING A BIO-MODEL COMPRISING A FLUID SYSTEM

(71) Applicant: UNIVERSITI MALAYA, Kuala Lumpur (MY)

(72) Inventors: Vickneswaran A/L MATHANESWARAN, Kuala Lumpur (MY); Zainal Ariff Bin ABDUL RAHMAN, Kuala Lumpur (MY); Yuwaraj Kumar A/L BALAKRISHNAN, Kuala Lumpur (MY); Su Tung TAN, Kuala Lumpur (MY)

(73) Assignee: UNIVERSITI MALAYA, Kuala Lumpur (MY)

(21) Appl. No.: 15/772,029

(22) PCT Filed: Oct. 28, 2016
(86) PCT No.: PCT/MY2016/050071

§ 371 Date: Apr. 27, 2018

(30) Foreign Application Priority Data
Oct. 28, 2015 (MY) PI 2015002657

(51) Int. Cl. G09B 23/30; G09B 23/34

(52) U.S. Cl. CPC G09B 23/303; B29C 64/386; G09B 23/34

(57) ABSTRACT

A bio-model for simulating a surgical procedure comprises a synthetic anatomical structure which has a cavity. A fluid system is coupled to the cavity. In one embodiment the fluid system allows fluid to be pressurized. In one embodiment, the fluid system allows fluid to flow through the cavity. The bio-model may be manufactured based on medical image data using three-dimensional printing.

### FIELD OF THE INVENTION

Embodiments of the present invention relate to three dimensional bio-models of anatomical structures comprising representations of features such as organs and tumors for use in simulating or practicing surgical procedures; and the manufacture of such bio-models.

### BACKGROUND OF THE INVENTION

Surgery is a difficult discipline to master. In order to develop and perfect their surgical skills, trainees and junior surgeons must repeatedly practice surgical procedures. Traditionally trainee surgeons have used cadavers to develop and practice their technique. The use of cadavers presents a number of issues: in many countries the use of cadavers is restricted for ethical and religious reasons; and the cost associated with preservation and disposal of is high. Further, in order to simulate many medical procedures an accurate representation of a specific pathology is required. An example of this is the simulation of the procedure required for the removal of a tumor. In such a case, the position, orientation, size and nature of the tumor will be unique to the pathology of a specific patient. Therefore a simulation based on a normal anatomy without the tumor will be of little or no benefit in for a surgeon preparing for the removal of a tumor.

Recent developments in three-dimensional printing techniques allow the production of three-dimensional bio-models of parts of the human anatomy which can assist surgeons in practicing their technique. The production of bio-models by these techniques allows accurate representations of the human body to be produced. The bio-models may be based on a specific patient and include accurate representations of the anatomy specific to that patient. Surgeons may use such bio-models to simulate and plan surgeries for specific patients as well as to practice general surgical techniques.

### SUMMARY OF THE INVENTION

According to a first aspect of the present invention there is provided a three dimensional bio-model comprising a synthetic anatomical structure defining at least one cavity, the at least one cavity having a fluid inlet; and a fluid system comprising a tube coupled to the fluid inlet and configured to allow a fluid in the at least one cavity to be pressurized.

Embodiments of the present invention allow surgical procedures to be simulated including pressurized synthetic anatomical structures. This may simulate swelling of the synthetic anatomical structures. The fluid system allows this pressure or swelling to be controlled either before the simulated surgical procedure or during the procedure.

Thus, embodiments of the present invention include a fluid system which allows the introduction of pressure inside the bio-model to create or replicate a condition that present in actual human.

In an embodiment, the bio-model further comprises a synthetic skin layer, wherein the tube passes through the synthetic skin layer. This allows the fluid system to be pressurized and the pressurization to be controlled from the exterior of the bio-model.

According to a second aspect of the present invention there is provided a three dimensional bio-model comprising a synthetic anatomical structure defining at least one cavity, the at least one cavity having a fluid inlet and a fluid outlet; and a fluid system comprising an inlet tube coupled to the fluid inlet; and an outlet tube coupled to the fluid outlet, the fluid system being configured to cause a fluid to flow through the cavity.

Embodiments of the present invention allow the circulation of fluids such as blood to be included in simulated surgical procedures. In embodiments, the use of the fluid system allows the flow of fluids which mimics the constituents of the fluid present in the actual fluid system in human.

In an embodiment, the bio-model further comprises a synthetic skin layer, wherein the inlet tube and the outlet tube pass through the synthetic skin layer.

In an embodiment, the bio-model comprises two parts: a base part and an insert which fits in a slot in the base part. The insert comprises the synthetic anatomical structure and the fluid system.

The insert provides an accurate representation of the internal anatomy which may be cut or otherwise changed during a simulated procedure. Therefore, the insert can only be used for one simulated procedure. Since the base part is not altered during a simulated procedure it can be reused. Therefore only the insert is discarded following a simulated procedure. This reduces the cost of each individual simulation since only the insert must be replaced.

The surface of the base part may accurately represent the surface of a part of a body such as a head or torso. This allows surgical navigation systems to be used during the simulated surgical procedure. Surgical navigation systems such as the Medtronic StealthStation S7 System use optical navigation cameras to assist a surgeon during surgery. The provision of a base part which accurately reproduces the surface features in an area around the simulated procedure location allows the use of the navigation system to be incorporated in the simulation of the surgical procedure.

Alternatively, the three dimensional bio-model may be produced as a single part.

According to a third aspect of the present invention, there is provided a method of manufacturing a three dimensional bio-model. The method comprises receiving medical image data for an anatomical structure. The medical image data may be captured from medical imaging apparatus such as a magnetic resonance imaging (MRI) apparatus, a computed tomography (CT) apparatus, an x-ray imaging apparatus, or an ultrasound apparatus. A three dimensional model is generated for the anatomical structure from the medical image data. Three dimensional data representing a fluid system is then added to the three dimensional model to provide bio-model structure data. The bio-model structure data is then three dimensional printed.

The use of three dimensional printing technology allows a bio-model to be produced that accurately represents the anatomy of a patient and the pathology of any diseases from which the patient is suffering.

The medical image data may be segmented. The segmentation may provide labels indicating parts of the anatomical structure. This segmentation may be applied by a clinician or may be automatically applied using image recognition software.

The bio-model may be printed as a plurality of separate parts which are assembled to form the complete bio-model.

The parts of the fluid system may be formed by tubes and the assembly may involve attaching the tubes to connectors on the synthetic anatomical structure. Thus, the fluid system may be provided by 3D printed elements such as tubes and pipes or may be produced in combination of existing materials together with the printed bio-model.

The fluid system maybe produced as whole in reference to actual system or highlighted and chosen to be replicate according to specific conditions or related structures.

Embodiments provide an anatomical model which permits the assessment of skin, tissues, structures, regions, bones and joints. The bio-model may possess similar properties such as thickness, feel or color to an actual organ or anatomy.

### BRIEF DESCRIPTION OF THE DRAWINGS

In the following, embodiments of the present invention will be described as non-limiting examples with reference to the accompanying drawings in which:

FIGS. 1a and 1b show a bio-model according to an embodiment of the present invention;

FIG. 2a shows the insertion of fluid into a bio-model according to an embodiment of the present invention;

FIG. 2b shows the internal structure of a bio-model according to an embodiment of the present invention;

FIG. 3 shows a bio-model according to an embodiment of the present invention which comprises a base piece and an insert; and

FIG. 4 is a flow chart showing a method of manufacturing a bio-model according to an embodiment of the present invention.

### DETAILED DESCRIPTION

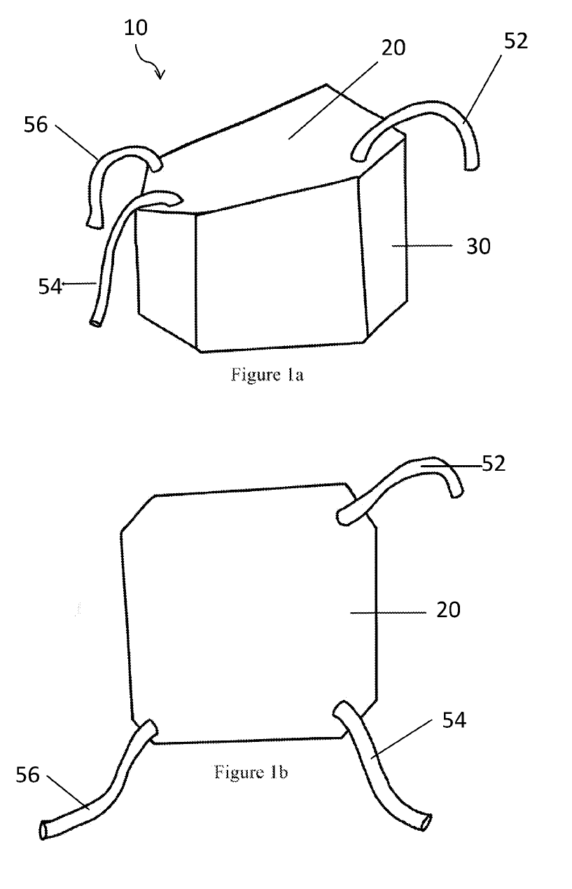

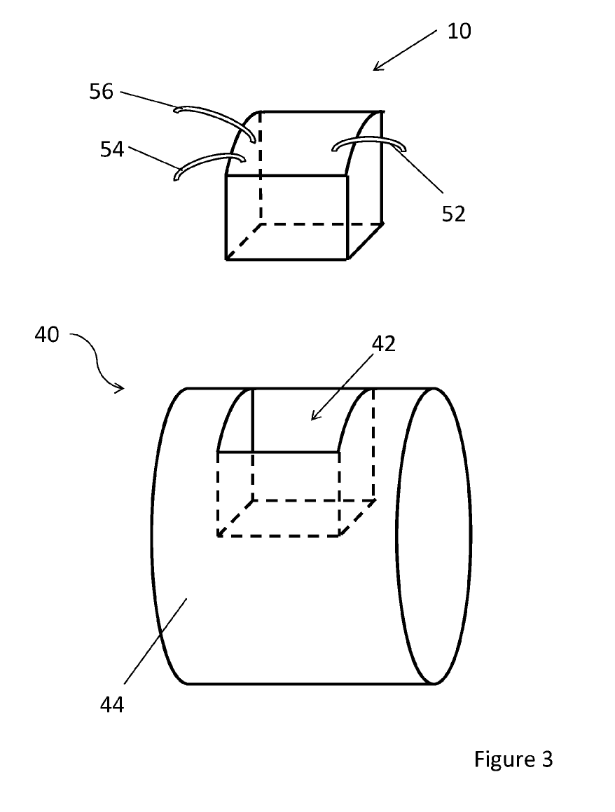

FIGS. 1a and 1b show a bio-model according to an embodiment of the present invention. FIG. 1a is a side view and FIG. 1b is a view from above. The bio-model 10 comprises a synthetic skin layer 20. The synthetic skin layer is configured to simulate the skin of a human patient and forms the top of the bio-model 10. The bio-model 10 has side walls 30 which are configured to allow the bio-model 10 to be inserted into a base piece which is described below with reference to FIG. 3.

A first tube 52, a second tube 54 and a third tube 56 pass through the synthetic skin layer. The tubes form part of a fluid system which allows fluid to be inserted into and pressurized in a synthetic anatomical structure located inside the bio-model.

As shown in FIG. 1b, the first tube 52, the second tube 54 and the third tube 56 are located around the periphery of the synthetic skin layer 20. The first tube 52, the second tube 54 and the third tube 56 are located close to corners of the synthetic skin layer 20. This means that the central area of the synthetic skin layer 20 is not interfered with by the tubes.

The bio-model 10 is used to simulate a surgical procedure. During this simulation, an incision is made in the central area of the synthetic skin layer 20. By placing the tubes at the periphery of the synthetic skin layer 20, it can be ensured that the tubes do not interfere with the simulated surgical procedure.

The bio-model 10 is a model of a part of the anatomy of a patient. The bio-model 10 may be a model of an organ or group of organs. The bio-model 10 may include representations of any of tissue, skin, bones, joints, organs. The bio-model 10 may incorporate pathological structures such as a tumor or conditions such as cuts resulting from a trauma.

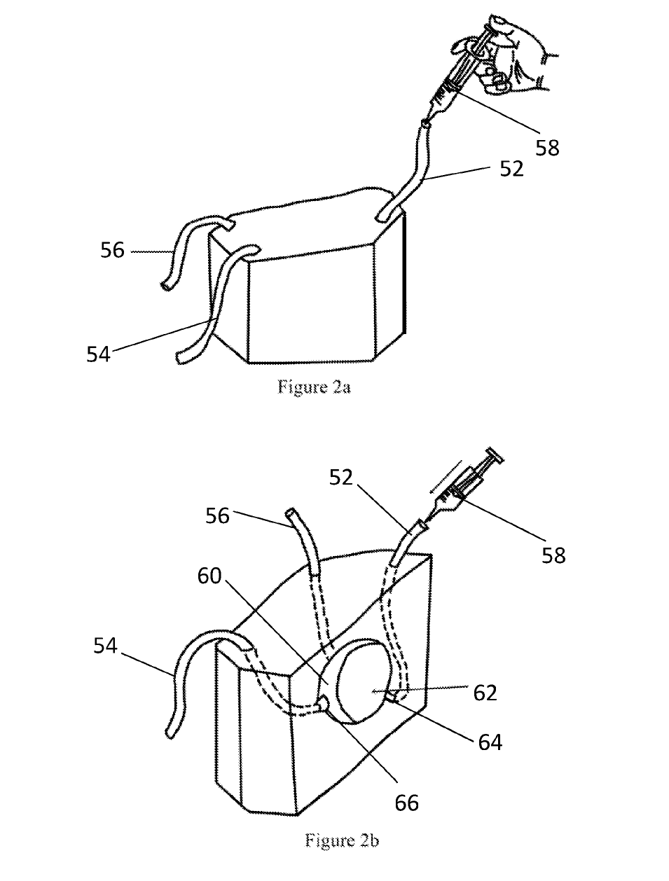

FIG. 2a shows the insertion of fluid into the bio-model 10. As shown in FIG. 2a, a syringe 58 is used to insert fluid into the first tube 52.

In an embodiment, the fluid inserted into the first tube 52 pressurizes fluid in a synthetic anatomical structure inside the bio-model 10. In this embodiment, the first tube 52 acts as a fluid inlet tube. In this embodiment, the fluid may either simulate fluid filled part of the anatomy such as an organ, or fluid filled pathological feature such as a tumour or a cyst. The fluid may be pressurised before the simulated surgical procedure is started and then the tubes may be closed with clamps or stoppers during the simulated surgical procedure. Alternatively, the fluid may be continuously pressurized during the simulated surgical procedure.

In another embodiment, the fluid inserted into the first tube 52 flows through a synthetic anatomical structure inside the bio-model 10 and out of the second tube 54 and/or the third tube 56. In this embodiment, the first tube 52 acts as a fluid inlet tube and the second tube 54 and/or the third tube 56 acts as a fluid outlet tube. In this embodiment, the fluid simulates a bodily fluid such as blood which circulates through the body. In this embodiment, the fluid may be pumped through the fluid system during the simulated surgical procedure to simulate, for example, blood circulation.

FIG. 2b shows the internal structure of a bio-model according to an embodiment of the present invention. As shown in FIG. 2b, the bio-model 10 comprises a synthetic anatomical structure 60. The synthetic anatomical structure 60 has a cavity 62. The cavity 62 has a fluid inlet 64 which is coupled to the first tube 52. Thus, fluid can be inserted into the cavity 62 via the first tube 52 using the syringe 58. The cavity 62 has a fluid outlet 66. The fluid outlet 66 is coupled to the second tube 54. As described above, fluid can be made to flow through the cavity 62 to simulate blood circulation. In such an embodiment, the first tube 52 may be connected to a constant fluid supply such as a tap to simulate constant fluid flow such as blood flow.

In an alternative embodiment, the second tube 54 and the third tube 56 may function as fluid inlets such that all of the tubes are used to pressurise the fluid in the cavity 62. An example of a condition with may be simulated is Hydrocephalus. Hydrocephalus is the build-up of too much cerebrospinal fluid in the brain. Under normal conditions the cerebrospinal fluid cushions the brain. However, when there is too much build-up of cerebrospinal fluid it puts harmful pressure on the brain. This pressure can be simulated using a bio-model 10 with a fluid system as described herein.

The bio-model may be manufactured from a wide variety of materials for example polymeric material, plaster, stainless steel, alloy or any two or more combination thereof.

In an embodiment, the bio-model 10 is an insert which fits into a slot in a base piece. This is shown in FIG. 3.

FIG. 3 shows a bio-model according to an embodiment of the present invention which comprises a base piece and an insert. The insert 10 is as described above in relation to FIGS. 1a, 1b, 2a and 2b. As described above, the sides of the insert may be formed as walls. The base piece 40 has a slot 42 into which the insert 10 can be fitted.

The exterior surface 44 of the base piece 40 has contours and features which correspond to the exterior of part of the body. For example, the base piece may include the contours and features of a human torso or the facial features of a human head.

While the exterior of the base piece 40 is shaped to simulate the corresponding parts of the human anatomy, the interior structure is not. The interior of the base piece 40 may be solid or hollow. During a simulated surgical procedure the insert 10 provides a simulation of the interior structure of the body being operated on. The base piece 40 provides a simulation of the exterior of the patient.

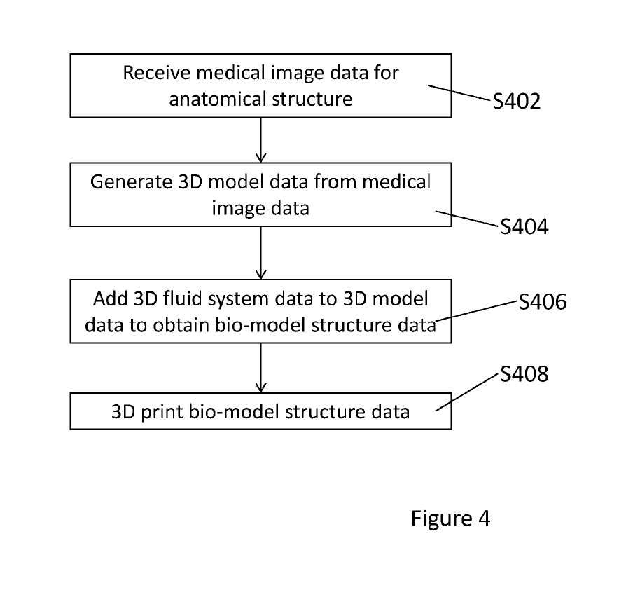

During many surgical procedures, surgical navigation systems are used by the surgeon for guidance. An example of a surgical navigation system is the Medtronic StealthStation S7 System. Such navigation systems use optical navigation to determine locations on a patient's body. The base piece 40 and insert 10 may be produced using scan data from a patient as described below with reference to FIG. 4 in more detail. Since the exterior surface 44 of the base piece 40 will correspond to this scan data, the base piece 40 provides an accurate simulation of the surgical procedure using the navigation system.

The insert 10 includes a top layer of synthetic skin 20 to simulate the skin of the patient during the simulated surgical procedure. During simulation of the surgical procedure, the surgeon will cut an incision or insert a probe through this skin layer. In addition, the surgeon may cut or alter the internal structure of the insert 10. Therefore, the insert 10 can normally only be used for one simulated surgical procedure and is then discarded. Since no changes are made to the base piece 40, it can be reused when the simulation is repeated, for example if the surgeon wishes to practice the same procedure a number of times or to alter certain aspects during planning of a surgical procedure. Therefore the amount of the model which is discarded can be reduced by providing a base piece which can be reused.

FIG. 4 is a flow chart showing a method of manufacturing a bio-model according to an embodiment of the present invention. The method shown in FIG. 4 may be carried out using a computer and a three dimensional printer.

In step S402, medical image data for an anatomical structure is received by the computer. The medical image data may be stored data obtained from a medical imaging apparatus such as a magnetic resonance imaging (MRI) apparatus, a computed tomography (CT) apparatus, an X-ray imaging apparatus, or an ultrasound imaging apparatus. The medical image data may be in the Digital Imaging and Communications (DICOM) format.

The medical image data received in step S402 may be segmented, that is, the various layers and tissues in the images may be labelled. This labelling may be implemented automatically using image analysis, or the images may be segmented manually by an operator.

In step S404, three dimensional model data is generated from the medical image data. The three dimensional model data is generated using a 3D conversion algorithm which generates three dimensional surfaces from the medical image data. Algorithms such as the marching cube algorithm, Delaunay's triangulation algorithm or a combination of the two may be used. The result of step S404 is a three dimensional model of the anatomical structure.

In step S406, the fluid system is added to the three dimensional model of the anatomical structure. The fluid system may be added using computer aided design (CAD) software. Parts of the fluid system may correspond to the true anatomy of the patient. The addition of the fluid system may involve selecting parts of the true anatomy for reinforcement so that the fluid system can withstand pressure from the insertion of fluid.

The scaffold is placed on the anatomical structures and the design may differ in accordance to the size and weight of the anatomical structures that it attaches to.

The size, weight and thickness of the fluid system differ based on the anatomical structures that will be produced and the relevant material that the anatomical structures will hold or contain.

The design of the fluid system is dependent on the application of the bio-model. The positioning of the fluid system around the anatomical structure is also selected based on the surgical procedure to be simulated. It is noted that while the anatomical structure is an accurate representation of part of the human anatomy, parts of the fluid system are not. Therefore parts of the fluid system, such as the positions where the first tube 52, the second tube 54 and the third tube 56 pass through the synthetic skin layer 20 are located in positions which interfere with the simulated surgical procedure. During the simulated surgical procedure, an incision would be made through the synthetic skin layer to expose part of the anatomical structure 60. The arrangement of the fluid system in the bio-model 10 would be designed so that the tubes which do not correspond to anatomically correct features would not be exposed during the simulated surgical procedure.

The fluid system applied on the bio-model 10 may be positioned according to referral to the relevant professionals. The variations in the position of the fluid system may be determined by the procedure or by the advice of the relevant professional as it is not to interrupt with the function of the bio-model.

The positioning of the fluid system may be standardized. For example, for a particular type of surgical simulation the locations and sizes of the tubes may be stored and then added to medical image data corresponding to a particular patient.

Alternatively, the positioning of the scaffold may be customized in accordance to the function of the bio-model 10. The position of the tubes may be varied in relation to any variations that occur in the medical image data obtained as any foreign objects such as tumours or abnormalities on the anatomical structure 60 or bio-model 10 may change the positioning of the tubes.

In step S308, the bio-model 10 is printed using three dimensional printing. The shape of the anatomical structure 60 and materials to be used for each anatomical region can be predetermined in the 3D data. By this way of predetermination and modification, accurate shape and material can be assigned to each anatomical region, beneficial specifically for pre-surgical training, surgical simulation and surgical training.

In one embodiment, the fluid system and anatomical structure 60 may be 3D printed together as a single structure using additive manufacturing technology. Alternatively, the bio-model 10 may be printed as a number of separate parts which are assembled. The fluid system may be produced separately from the anatomical structure 60. For example, the synthetic anatomical structure 60 may be 3D printed with connectors at the fluid inlets and/or fluid outlets. The tubes may either be separately 3D printed and attached during assembly, or tubes produced by other manufacturing techniques may be attached during the assembly. When the fluid system is produced separately, post-processing assembly and post-processing procedure may be applied to produce the complete bio-model 10. The fluid system may be produced with the same material or from a different material as the material used to produce the anatomical structure 60.

In an embodiment, the 3D data is subjected to a rapid additive manufacturing technique where layers of material are added upon one another to form the 3D anatomical structure. The rapid additive manufacturing techniques used to produce the bio-model 10 may include layered manufacturing, direct digital manufacturing, laser processing, electron beam melting, aerosol jetting, inkjet printing or semi-solid free-form fabrication. The 3D data enables the rapid additive manufacturing machine to sequentially build up many thin layers upon another to build the 3D bio-model.

The fluid system may be produced with a single type of material or multiple materials depending on the desired properties and the manufacturing technology used. The production of the fluid system may involve construction by combination of existing pre-fabricated parts such as tubes, pipes and stoppers or may be fabricated by 3D printing in parts and then assembled. Alternatively, the bio-model including the fluid system may be 3D printed.

As described above, embodiments of the present invention provide a bio-model with a fluid system that simulates fluid or pressure in a synthetic anatomical structure. The bio-model is produced using medical image data and there provides a 3D model that accurately simulates the actual anatomical structure. The 3D model represents the selected structures, organs or any region of interest and pathology of the disease.

Embodiments of the present invention provide an accurate anatomical model which serves as tool for a better understanding on the condition of a patient or the procedure for operating on a patient.

Whilst the foregoing description has described exemplary embodiments, it will be understood by those skilled in the art that many variations of the embodiment can be made within the scope and spirit of the present invention.

1. A bio-model comprising
a synthetic anatomical structure defining at least one cavity, the at least one cavity having a fluid inlet; and
a fluid system comprising a tube coupled to the fluid and configured to allow a fluid in the at least one cavity to be pressurized.

2. A bio-model according to claim 1, further comprising a synthetic skin layer, wherein the tube passes through the synthetic skin layer.

3. A bio-model comprising
a synthetic anatomical structure defining at least one cavity, the at least one cavity having a fluid inlet and a fluid outlet; and
a fluid system comprising an inlet tube coupled to the fluid inlet; and an outlet tube coupled to the fluid outlet, the fluid system being configured to cause a fluid to flow through the cavity.

4. A bio-model according to claim 3, further comprising a synthetic skin layer, wherein the inlet tube and the outlet tube pass through the synthetic skin layer.

5. A three dimensional bio-model according to claim 1 configured to be insertable into a slot in a base piece.

6. A three dimensional bio-model according to claim 1, comprising a base piece and an insert, the base piece defining a slot, the insert being configured to fit into the slot, the insert comprising the synthetic anatomical structure and the fluid system.

7. A three dimensional bio-model according to claim 6, the surface of the base piece having contours and/or features selected to mimic an external anatomy.

8. A method of manufacturing a three dimensional bio-model, the method comprising
receiving medical image data for an anatomical structure;
generating three dimensional model data for the anatomical structure from the medical image data;
adding three dimensional fluid system structure data to the three dimensional model data for the anatomical structure to provide bio-model structure data; and
three dimensional printing the bio model structure data.

9. A method according to claim 8, wherein the medical image data is segmented medical image data comprising indications of parts of the anatomical structure.

10. A method according to claim 8, wherein the three dimensional model data for the anatomical structure comprises an indication of at least one cavity and the three dimensional fluid system structure data comprises an indication of a tube coupled to the at least one cavity.

11. A method according to claim 8, wherein the three dimensional model data for the anatomical structure comprises an indication of at least one cavity and the three dimensional fluid system structure data comprises an indication of a connector for a tube coupled to the at least one cavity.

12. A method according to claim 11, further comprising connecting a tube to the connector after three dimensional printing the bio-model structure data.

13. A method according to claim 8, wherein the bio-model structure data comprises structure data for a plurality of bio-model parts, and three dimensional printing the bio-model structure data comprises three dimensional printing each of the plurality of bio-model parts separately, the method further comprising assembling the bio-model parts to form the bio-model.

14. A method according to claim 8, wherein the bio-model is configured to be insertable into a slot in a base piece.
